(19) United States
(12) Patent Application Publication
(10) Pub. No.: US 2022/0217571 A1
(43) Pub. Date: Jul. 7, 2022

(54) Method Performed by a Core Network Node for Deciding How to Shape a Specific Data Flow

(71) Applicant: Telefonaktiebolaget LM Ericsson (publ), Stockholm (SE)

(72) Inventors: Robert Skog, Hässelby (SE); Hans Hannu, Luleå (SE); Mathias Sintorn, Sollentuna (SE); Jonas Pettersson, Luleå (SE)

(21) Appl. No.: 17/612,234

(22) PCT Filed: Apr. 14, 2020
(86) PCT No.: PCT/SE2020/050384

§ 371 Date: Nov. 18, 2021

Related U.S. Application Data
(60) Provisional application No. 62/850,569, filed on May 21, 2019.

(51) Int. Cl. H04W 28/02; H04L 47/2475; H04L 47/22

(52) U.S. Cl. CPC H04W 28/0263; H04L 47/2475; H04W 88/14; H04W 28/0268; H04L 47/22

(57) ABSTRACT

A method performed by a core network node for deciding how to shape a specific data flow out of a number of data flows between a Radio Access Network, RAN, node and multiple User Equipments, UEs, in a wireless communications network is provided. The core network node obtains (502) a second information. The second information is about which specific data flow out of the number of data flows. The specific data flow will benefit other data flows out of the number of data flows, when shaping the specific data flow such that the bit rate of the specific data flow exceeds a threshold. The second information is based on a first information. The first information comprises for each data flow out of the number of data flows, information about the number of bits per radio resource of the data flow based on radio conditions of the UE involved in the data flow. The core network node then decides (503) how to shape the specific data flow, based on the second information.

### TECHNICAL FIELD

Embodiments herein relate to a core network node, a Radio Access Network (RAN) node and methods therein. In some aspects, they relate to deciding how to shape a specific data flow out of a number of data flows between the RAN node and multiple User Equipments (UEs) in a wireless communications network.

### BACKGROUND

In a typical wireless communication network, wireless devices, also known as wireless communication devices, mobile stations, stations (STA) and/or User Equipments (UE), communicate via a Local Area Network such as a W-Fi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a W-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a 5G network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques may significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

Today, video is sent to devices such as UEs, using adaptive bit rate streaming, also known as Adaptive Bit Rate (ABR) streaming. ABR streaming is a technique used in streaming multimedia over computer networks. While in the past most video or audio streaming technologies utilized streaming protocols such as Real-time Transport Protocol (RTP) with Real Time Streaming Protocol (RTSP), today's adaptive streaming technologies are almost exclusively based on Hypertext Transfer Protocol (HTTP) and designed to work efficiently over large distributed HTTP networks such as the Internet.

ABR works by detecting a user's bandwidth and CPU capacity in real time and adjusting the quality of the media stream accordingly. It requires the use of an encoder which can encode a single source media e.g. video or audio, at multiple bit rates.

FIG. 1 depicts ABR adapting to different network conditions having different available bandwidth including network congestion by selecting a high bit rate media stream or a medium bit rate media stream or a low bit rate stream.

### SUMMARY

An object of embodiments herein is to improve the total number of users being satisfied with their current service session experience, in a wireless communications network using handover such as an ABR video session, for a selected cell. The wording “to be satisfied with a user's current service session experience” when used herein may mean that the used bit rate is above a threshold that is decided to be acceptable for a user.

According to an aspect of embodiments herein, the object is achieved by a method performed by a core network node for deciding how to shape a specific data flow out of a number of data flows between a Radio Access Network, RAN, node and multiple User Equipments, UEs, in a wireless communications network. The core network node obtains a second information. The second information is about which specific data flow out of the number of data flows. The specific data flow will benefit other data flows out of the number of data flows, when shaping the specific data flow such that the bit rate of the specific data flow exceeds a threshold. The second information is based on a first information. The first information comprises for each data flow out of the number of data flows, information about the number of bits per radio resource of the data flow based on radio conditions of the UE involved in the data flow. The core network node then decides (503) how to shape the specific data flow, based on the second information.

According to another aspect of embodiments herein, the object is achieved by a method performed by a Radio Access Network, RAN, node for assisting a core network node in deciding how to shape a specific data flow out of a number of data flows between the RAN node and multiple User Equipments, UEs, in a wireless communications network. For each data flow out of the number of data flows, the RAN node obtains a first information about the number of bits per radio resource of the data flow based on a measured radio conditions of the UE involved in the data flow. Based on the obtained first information about the number of bits per resource of the respective data flow, the RAN node obtains a second information about which specific data flow out of the number of data flows, that will benefit other data flows out of the number of data flows, when shaping the specific data flow such that the bit rate of the specific data flow exceeds a threshold. The RAN node then sends information in a message to the core network node. The information comprises any one out of: the first information or the first information and the second information, which information enables the core network node to decide how to shape the specific data flow.

According to another aspect of embodiments herein, the object is achieved by a core network node configured to decide how to shape a specific data flow out of a number of data flows between a Radio Access Network, RAN, node and multiple User Equipments, UEs, in a wireless communications network. The core network node is further configured to:
Obtain a second information about which specific data flow out of the number of data flows, that will benefit other data flows out of the number of data flows, when shaping the specific data flow such that the bit rate of the specific data flow exceeds a threshold, which second information is based on a first information comprising for each data flow out of the number of data flows, information about the number of bits per radio resource of the data flow based on radio conditions of the UE involved in the data flow, and
decide how to shape the specific data flow, based on the second information.

According to yet another aspect of embodiments herein, the object is achieved by a Radio Access Network, RAN, node configured to assist a core network node in deciding how to shape a specific data flow out of a number of data flows between the RAN node and multiple User Equipments, UEs, in a wireless communications network. The RAN node is further configured to:
For each data flow out of the number of data flows, obtain a first information about the number of bits per radio resource of the data flow based on a measured radio conditions of the UE involved in the data flow,
based on the obtained first information about the number of bits per resource of the respective data flow, obtain a second information about which specific data flow out of the number of data flows, that will benefit other data flows out of the number of data flows, when shaping the specific data flow such that the bit rate of the specific data flow exceeds a threshold, and
send information in a message to the core network node, which information is adapted to comprise any one out of: the first information or the first information and the second information, which information enables the core network node to decide how to shape the specific data flow.

It is furthermore provided herein a computer program product comprising instructions, which, when executed on at least one processor, cause the at least one processor to carry out any of the methods above, as performed by the user equipment or the radio network node. It is additionally provided herein a computer-readable storage medium, having stored there on a computer program product comprising instructions which, when executed on at least one processor, cause the at least one processor to carry out the method according to any of the methods above, as performed by the radio network node or the user equipment.

### BRIEF DESCRIPTION OF THE DRAWINGS

Examples of embodiments herein are described in more detail with reference to attached drawings in which:

FIG. 1 is a schematic diagram illustrating prior art.

FIG. 2 is a schematic block diagram illustrating prior art.

FIG. 3 is a schematic block diagram illustrating embodiments of a wireless communications network

FIGS. 4 a and b are schematic diagrams illustrating results of using embodiments herein.

FIG. 5 is a flowchart depicting embodiments of a method in a core network node.

FIG. 6 is a flowchart depicting embodiments of a method in a RAN node.

FIG. 7 is a schematic block diagram illustrating embodiments herein.

FIG. 8 is a schematic block diagram illustrating embodiments herein.

FIG. 9 is a schematic block diagram illustrating embodiments herein.

FIGS. 10 a and b are schematic block diagrams illustrating an embodiment of a core network node

FIGS. 11 a and b are schematic block diagrams illustrating an embodiment of a RAN node.

FIG. 12 schematically illustrates a telecommunication network connected via an intermediate network to a host computer.

FIG. 13 is a generalized block diagram of a host computer communicating via a base station with a user equipment over a partially wireless connection.

FIGS. 14-17 are flowcharts illustrating methods implemented in a communication system including a host computer, a base station and a user equipment.

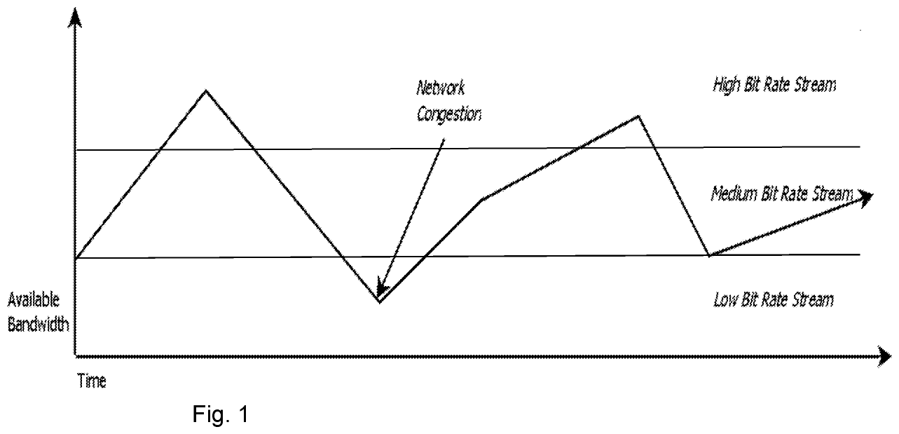

### DETAILED DESCRIPTION

As a part of developing embodiments herein a problem was identified by the inventors and will first be discussed.

WO2017193970-A1 teaches a system and method for supporting operation of mobile communication network. The system and method provides for a quality-guaranteed communication channel (e.g. QQGC) to carry data flows, such as video, audio, live or time-sensitive data flows, or other types of data: The channel is characterized at least by an effective bit rate (EBR) an average bit rate (ABR) and a maximum bit rate (MBR).

In this system, information about the flows is sent from the CN to the RAN. The EBR may be used as one of the input parameters for system resource management functions, such as RRO in radio access network (RAN), user plane path selections, and resources (e.g., computing, in-network storage) selection in RAN and CN.

Further, CN informs RAN about the quality the flow shall have, and Ran itself checks the kind of flow, e.g. video etc.

RAN sends information to RAN about which flows that consumes much RAN resources and performs shaping on just those flows which in turn benefits other flows in the cell. The CN then decides whether or not to perform the shaping based on the type of flow or the type of subscription.

“The Content requirement Awareness function in the RAN (CAF-RAN) 350 supports a mechanism to identify the application sessions in case (e.g., a video download, a web page download, listening to music, posting to social media network, etc.) and to enforce QoS policies. It receives QoS policies from the Core CP.

A disadvantage with this method is that that the RAN savings will not be fully utilized.

WO2013123467-A1 discloses a hierarchical traffic differentiating method for handling network traffic congestion involves scheduling differentiated traffic for transmission based on prioritization of multiple traffic sub-classes. In this disclosure, different flows are sent with different priority within the same bearer. No information is sent from RAN about the resource status of the different flows in the cell. A disadvantage with this method is that it is not possible to find flows that consume much RAN resources and if that flow can be shaped will save RAN resources so that other (and new) flows can use those freed resources.

US2017359749 discloses a method for monitoring quality of service (QoS) policy enforcement of network function and user equipment. The method involves transmitting signal and traffic parameters with short and long-term measurement window enforcement at plane function network. By changing the shape of traffic demand, QoS and QoE guarantees can be met, but instantaneous traffic demands can be handled in a manner that does not cause problems for other flows.”

The CN conveys the classification of the UP traffic belonging to a QoS flow through an N3 (and N9) UP marking using a QFI. The AN 120 binds 722 QoS flows to AN resources 724 (i.e. Data Radio Bearers in case of in case of 3GPP RAN).” A disadvantage with this method is that it is not possible to find flows that consume much RAN resources and if that flow can be shaped will save RAN resources so that other (and new) flows can use those freed resources.

Mobile operators apply data traffic shaping in the core network for various reasons. A common type of shaping is the ABR shaping and it is applied to video flows to reduce the volume consumed by a video flow. The traffic shaping is performed in a core network node such as a Packet Data Network Gateway (PGW), Traffic Detection Function (TDF) or some other General Packet Radio Service Interface (GI) function.

Today services like a stream saver where videos are shaped to e.g. 1.5 Mbit/s and is not calculated towards your data plan find out, e.g. via RTT measurements, if a cell is congested. When the cell is congested, the shaping level of the involved data flow is set to e.g. 1.2 Mbit/s or if the cell congestion is heavy the shaping level of the involved data flow is set to e.g. 0.9 Mbit/s. This congestion aware shaping is combined with Radio Friendly Shaping (RFS), where burst sizes and the quiescence periods are determined by the shaping level.

A quiescence period when used herein is a short time when no data is sent.

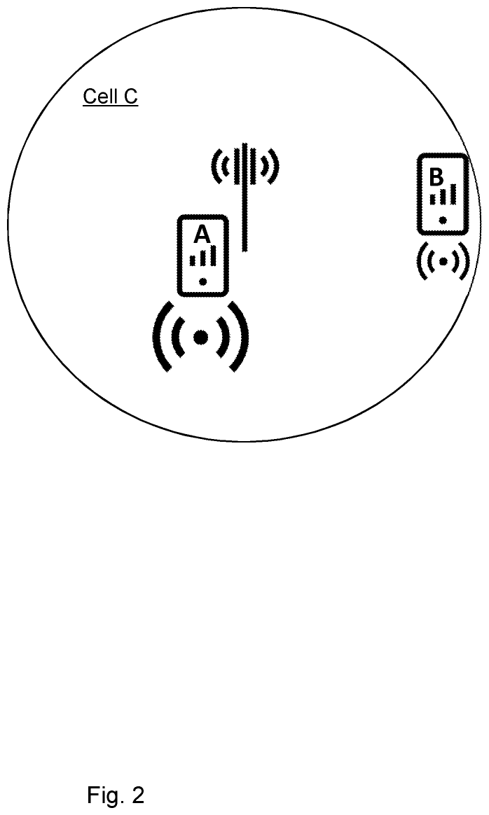

FIG. 2 depicts two users, e.g. UEs, A and B that are located in a congested cell C. The UEs A and B are in different parts in the cell and therefore have different radio conditions. The users A and B both have at least one data flow ongoing or upcoming.

During periods of high load, applied resource fairness in RAN does not necessarily maximize the service experience. For example, due to the difference in radio condition the UE A would get higher bit rate than the UE B if the resources in RAN are shared equal. Hence, a core network node that is made aware or able to detect the state of a cell and its user conditions may with its knowledge about service characteristics enhance an ABR shaping service.

An object of embodiments herein is to improve the total number of users being satisfied with their current service session experience, such as an ABR video session, for a selected cell. The wording “to be satisfied with a user's current service session experience” when used herein may mean that the used bit rate is above a threshold that is decided to be acceptable for a user.

Embodiments herein relate to wireless communication networks in general. FIG. is a schematic overview depicting a wireless communications network 100. The wireless communications network 100 comprises one or more RANs and one or more CNs. The wireless communications network 100 may use a number of different technologies, such as W-Fi, Long Term Evolution (LTE), LTE-Advanced, 5G, New Radio (NR), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the wireless communications network 100 such as e.g. a RAN node 110. The RAN node 110 provides radio coverage in a number of cells which may also be referred to as a beam or a beam group of beams.

The RAN node 110 may be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), new generation (ng)NB, a base transceiver station, a radio remote unit, an Access Point Base Station, a base station router, a transmission arrangement of a radio base station, a stand-alone access point or any other network unit capable of communicating with a wireless device within the service area served by the RAN node depending e.g. on the first radio access technology and terminology used. The RAN node 110 may be referred to as a serving radio network node and communicates UEs in its provided cell, such as a UE 121, a UE 122, and a UE 123. The RAN node 110 communicates with a UE with Downlink (DL) transmissions to the UE and Uplink (UL) transmissions from the UE.

In the wireless communication network 100, one or more UEs operate, such as e.g. the UE 121, the UE 122, and the UE 123. Each UE 121, 122, 123, 124 may also referred to as a user, a data flow, a flow, a device, an loT device, a mobile station, a non-access point (non-AP) STA, a STA, a user equipment and/or a wireless terminals, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

According an example scenario herein, the RAN node 110 transfers data for the UEs 121, 122, 123, 124 in a number of data flows, wherein each of UEs 121, 122, 123, has at least one ongoing or upcoming data flow.

One or more core network nodes operate in the wireless communication network 100, such as e.g. the core network node 130. The core network node 130 may e.g. be any one out of a Packet Gateway (PGW), a User Plane Function (UPF) and a Traffic Detection Function (TDF).

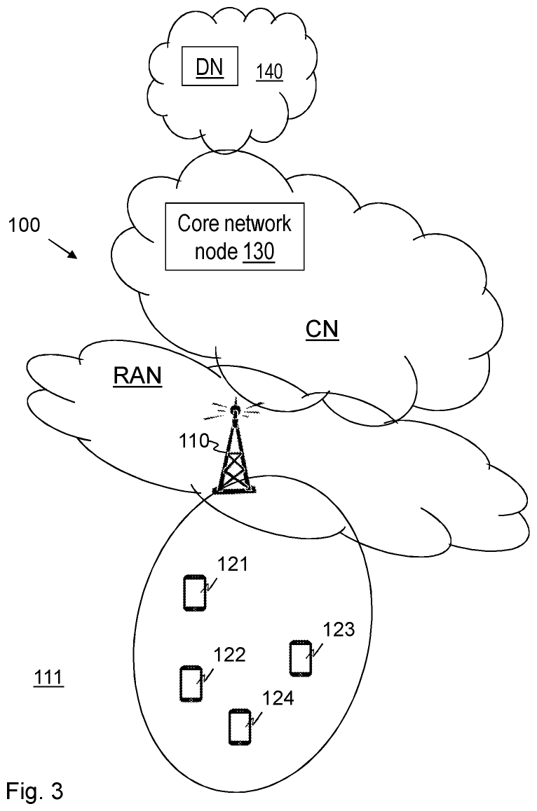

Methods herein may be performed by the core network node 130 and the RAN node 110. As an alternative, a Distributed Node (DN) and functionality, e.g. comprised in a cloud 140 as shown in FIG. 3, may be used for performing or partly performing the methods herein.

According to embodiments herein, it is possible for the RAN node 110 to find knowledge, e.g. by measurements and reports from the UEs 121, 122, 123, 124, about the UEs 121, 122, 123, 124, radio conditions. With the knowledge of the respective UEs 121, 122, 123, 124, radio conditions a function also referred to as first function, may calculate the number of bits per resource the UEs 121, 122, 123, 124 may receive and send per scheduling occasion. This may be translated to the number of bits per data flow per resources.

Further, a second function will based on the first function, calculate which flows that may be shaped to increase the number of users (receivers of the data flows) being satisfied with their respective session experience, i.e. that their used bit rate is above a threshold that is decided to be acceptable for a user This may be performed in the core network node or the RAN node. The calculation may use additional information such as the amount of data each UE 121, 122, 123, 124 has produced, and/or produces and/or may produce and the service type and QoS requirement.

This may mean that UEs with worse RAN conditions also gets satisfied while users with good and excellent radio conditions are still satisfied with their session experience.

Embodiments herein will make more users out of the UEs 121, 122, 123, 124 being satisfied with their session experience. E.g. a data flow such as an ABR session, when the data flow shaping is done based on information previously not used nor known in core network shapers, and hence the RAN node 110 scheduling mechanism and core network node 130 shapers implicitly work together to provide the most suitable experience for a use such as the UEs 121, 122, 123, 124. A data flow for a UE 121, 122, 123, 124 may only be shaped when the overall bitrate for the UEs 121, 122, 123, 124 in the cell is improved by the data flow shaping.

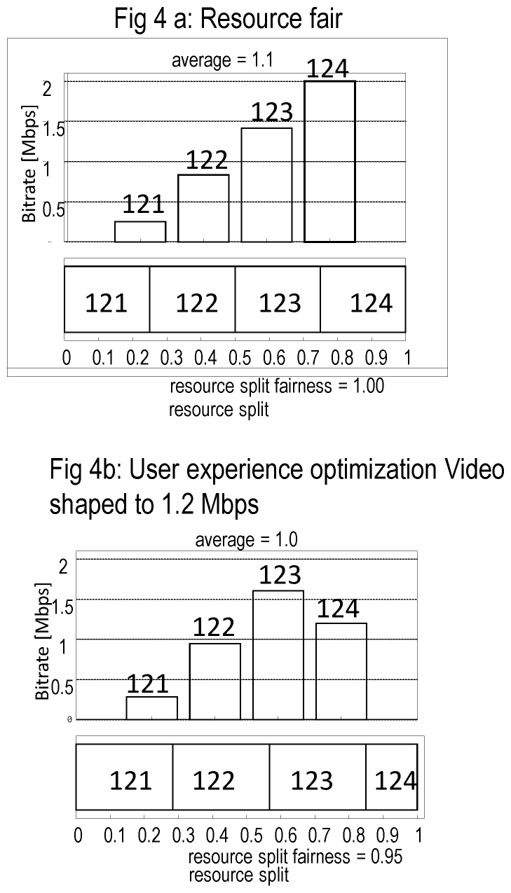

FIGS. 4a and b depicts an example of results of data flow shaping. In the example scenario of FIG. 4a, there are four UEs, the UEs 121, 122, 123, 124. This figure shows the scenario before the flow shaping according to embodiments herein. They have different radio conditions, with better conditions to the right.

The example scenario of FIG. 4b shows the four UEs 121, 122, 123, 124, after the flow shaping according to embodiments herein.

The UEs 121, 122, and 124 have a video session and the UE 123 has a web session. In FIG. 4b, the far right most UE 124 is shaped to 1.2 Mbps. Both the UE 123 and the UE 122 gets an improved bit-rate due to the shaping in the core network node 130. This is thanks to that more radio resources are made available to the other three UEs 121, 122, and 123 in the cell.

By combining Core network node 130 knowledge, about the type of service with corresponding QoS requirement for that service, with RAN node 110 knowledge, about UEs 121, 122, 123, 124, or data flows radio condition, the data flows of a specific UE among the UEs 121, 122, 123, 124 may be shaped without the bit rate of the specific data flow being below a threshold. In this way available RAN node 110 resources may be used by other UEs of the 121, 122, 123, 124, in that cell. This results in RAN User Experience Optimization for the UEs 121, 122, 123, 124.

In other words, by combining Core network node 130 such as UPF, PGW, and/or TDF knowledge such as first information about the type of service with corresponding QoS requirement for that service with RAN node 110 knowledge such as second information about UEs 121, 122, 123, 124, or data flows radio condition, the data flows of a specific UE out of the UEs 121, 122, 123, 124 may be shaped without the bit rate of the specific data flow being below a threshold and available RAN node 110 resources may be used by other UEs out of the 121, 122, 123, 124 in that cell. This results in RAN User Experience Optimization for the UEs 121, 122, 123, 124.

The RAN node 110 may convey its knowledge such as the second information and/or first and second information e.g. in the form of how many bits of a data flow that can be transferred per resource, or by conveying which flows can/will or may benefit other flows if shaped.

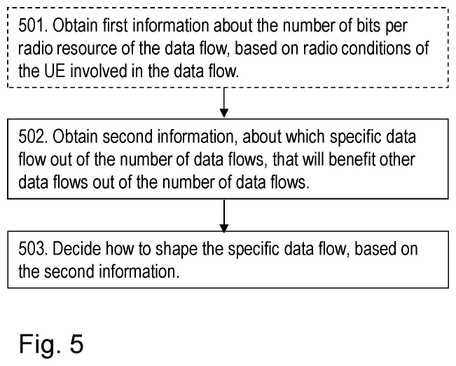

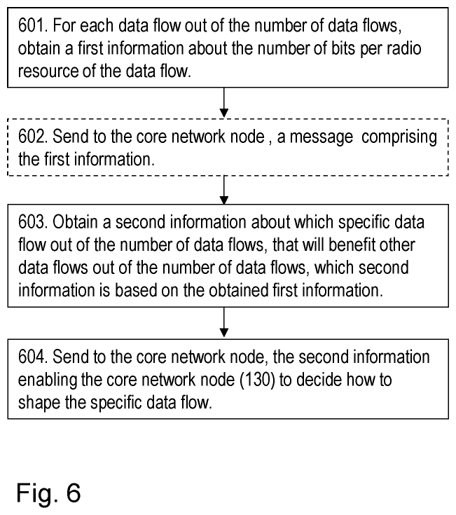

Embodiments herein will first be described in a more general way together with FIGS. 5 and 6. This will be followed by a more detailed description of the embodiments.

FIG. 5 shows example embodiments of a method performed by the core network node 130 for deciding how to shape a specific data flow out of a number of data flows between a Radio Access Network, RAN, node 110 and multiple User Equipments, UEs, 121, 122, 123, 124 in a wireless communications network 100 The method comprises the following actions, which actions may be taken in any suitable order.

The wording “shaping a data flow” when used herein e.g. means to limit max bitrate and/or bandwidth of the flow.

Action 501

A first information obtained by the RAN node 110, e.g. referred to as a first function, may in some embodiments be sent to the core network node 130 and in some embodiments not. The first information will be used as a basis to obtain a second information e.g. referred to as a second function. This will be explained in detail below.

Thus in some embodiments, for each data flow out of the number of data flows, the core network node 130 obtains a first information. The first information is about the number of bits per radio resource of the respective data flow and is based on radio conditions of the respective UE 121, 122, 123, 124 involved in the data flow.

The first information may be obtained by being received in a message from the RAN node 110.

Action 502

In order to shape a specific data flow of a UE among the UEs 121, 122, 123, 124 without the bit rate of the specific data flow becomes below a threshold, the first information and the second information will be used as a basis to identify such specific data flow of a UE among the flows of the UEs 121, 122, 123, 124.

The second information is obtained by the core network node 130 e.g. by being calculated by the RAN node 110 and sent to the core network node 130, or be calculated by the core network node 130. The second information will be used as a basis to decide how to shape the specific data flow identified in the second information.

The core network node 130 obtains the second information. The second information is about which specific data flow out of the number of data flows, that will benefit other data flows out of the number of data flows, when shaping the specific data flow such that the bit rate of the specific data flow exceeds a threshold. The second information is based on the first information. This may mean that shaping is triggered if the specific data flow exceeds a threshold.

In some embodiments, the second information may be obtained by being calculated in the core network node 130, e.g. based on any one or more out of:
The amount of data related to each UE out of the multiple UEs 121, 122, 123, 124 for its one or more data flows out of the number of data flows,
the service type of the respective data flow out of the number of data flows, and
the QoS requirement of the respective data flow out of the number of data flows.

In some other embodiments, the second information is obtained by being received in a message from the RAN node 110.

Action 503 The core network node 130 then decides how to shape the specific data flow, based on the second information, which in turn is based on the first information.

The shaping of the specific data flow may e.g. comprise lowering bit rate of the specific data flow, lowering the burst rate of the specific data flow, changing the size of bursts in the specific data flow.

The deciding of how to shape the specific data flow may further be based on any one or more out of: The type of data flow of the specific data flow and the QoS of the type of data flow of the specific data flow.

Both the first information and the second information may e.g. be received in a General packet radio service Tunneling Protocol-User plane (GTP-U) extension header of a message, or a user plane Internet Protocol (IP) message. This will be explained more below.

FIG. 6 shows example embodiments of a method performed by the RAN node for assisting a core network node 130 in deciding how to shape a specific data flow out of a number of data flows between the RAN node 110 and multiple User Equipments, UEs, 121, 122, 123, 124 in a wireless communications network 100. The method comprises the following actions, which actions may be taken in any suitable order.

Action 601.

For each data flow out of the number of data flows, the RAN node 110 obtains the first information about the number of bits per radio resource of the data flow based on a measured radio conditions of the UE 121, 122, 123, 124 involved in the data flow. This may be referred to as the first function.

Action 602. In some embodiments, the RAN node 110 sends the first information e.g. in a message to the core network node 130. In some embodiments, the first information is sent to the core network node 130 e.g. if the second information is to be calculated by the core network node 130. In some other embodiments, e.g. if the second information is to be calculated by the RAN node 110, only the second information may sent to the core network node 130.

Action 603

Based on the obtained first information about the number of bits per resource of the respective data flow, the RAN node 110 obtains the second information. The second information is based on the obtained first information about the number of bits per resource of the respective data flow. The second information is about which specific data flow out of the number of data flows, that will benefit other data flows out of the number of data flows, when shaping the specific data flow such that the bit rate of the specific data flow exceeds a threshold. This may be referred to as the second function.

The second information may e.g. be calculated by the RAN node 110.

Action 604

The RAN node 110 then sends information in a message to the core network node 130. The information comprises any one out of: The first information and the second information or only the first information. This information enables the core network node 130 to decide how to shape the specific data flow.

In some embodiments, wherein only the first information is sent to the core network node 130, the core network node 130 will calculate the second information based on the first information and then decide how to shape the specific data flow, which will be based on the second information.

In some other embodiments, wherein both the first information and the second information is sent to the core network node 130, the core network node 130 will only decide how to shape the specific data flow, which will be based on the second information.

The shaping of the specific data flow may e.g. be to lowering bit rate of the specific data flow, to lowering the burst rate of the specific data flow, and/or to change the size of bursts in the specific data flow.

As hinted above, the second information may be obtained in Action 603 by being calculated based on any one or more out of: The amount of data related to each UE out of the multiple UEs 121, 122, 123, 124 for its one or more data flows out of the number of data flows, the service type of the respective data flow out of the number of data flows, and the QoS requirement of the respective data flow out of the number of data flows. Both the first information and the second information may be sent to the core network node 130 a GTP-U extension header of a message, or a user plane IP message.

The above embodiments will now be further explained and exemplified below. The above embodiments may be combined with any suitable embodiments below.

Embodiments herein will now be described with respect to the architecture of a cellular system of the wireless communications network 100, such as 4G LTE or 5G NR.

The flow shaper is in the core network such as the core network node 130 of the cellular systems. The RAN such as the RAN node 110 has knowledge about UEs 121, 122, 123, 124 radio conditions and host the first function that calculates the number of bits per resource of a data flow of the UE 121, 122, 123, 124 such as the user of the UE 121, 122, 123, 124.

Depending on in which one of the RAN node 110 and the core network node 130 the of the second function is performed, that is the second function that calculates which data flows that may be shaped to increase the number of UEs, also referred to as receivers of the data flows, being satisfied with their session experience, meaning that the used bit rate is kept above the threshold that is decided to be acceptable for a user, there are two alternative embodiments herein.

Embodiments Wherein the Core Network Node 130 Performs the Second Function

In these embodiments wherein the RAN such as the RAN node 110 conveys the first information comprising for each data flow out of the number of data flows, information about the number of bits per radio resource of the data flow to the core network node 130 The first information may e.g. comprise bits and/or resource, and cell ID.

In these embodiments the second function is in the core network such as the core network node 130, being the data flow shaper. The RAN node 110 thus conveys the first information, e.g. bits and/or resource, and cell ID to the core network node 130 for all flows of the respective UE 121, 122, 123, 124.

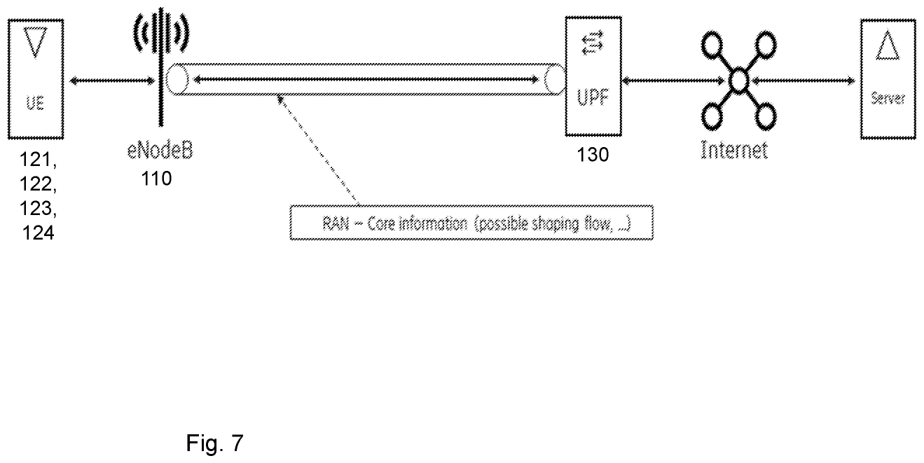

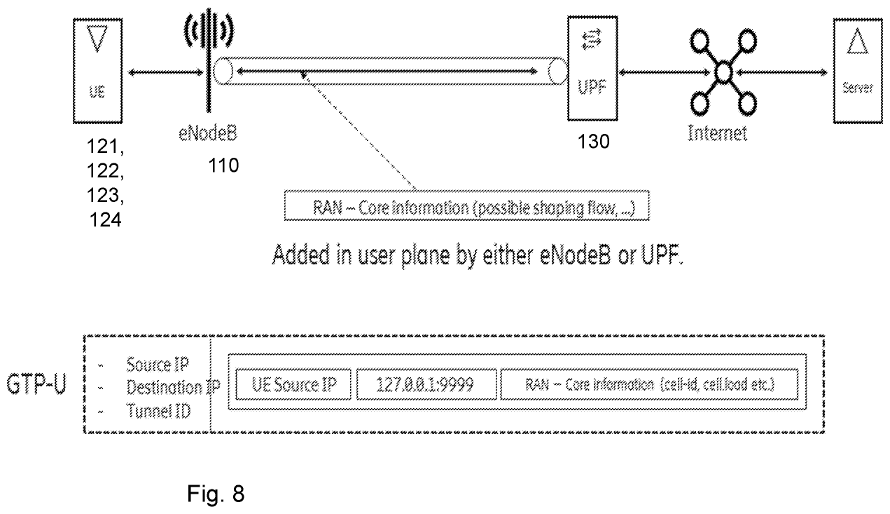

GTP-U protocol or other protocol messages may be carriers of the information between the RAN such as the RAN node 110 and the core network such as the core network node 130. See FIG. 7 and FIG. 8.

The second function is in the core network node 130 and will obtain the second information by calculating which flows that may be shaped to increase the number of users out of the UEs 121, 122, 123, 124, also referred to as receivers of the data flows, being satisfied with their session experience. The calculation may use additional information such as e.g. the amount of data each UE 121, 122, 123, 124 has produced, and/or produces and/or may produce and the service type and QoS requirement e.g. for the service type.

It is an advantage if the second function also knows the scheduling principles of the RAN such as the RAN node 110 to be able to estimate how the resources are assigned without shaping, for example we can assume an equal split of resources.

The procedure of the second function may e.g. be for the core network node 130 to;
1. Identify the flows that may be shaped, e.g. using the additional information as given above. For example, if the flow is an ABR video, and the flow is currently having a bit rate exceeding a shaping rate, the flow is identified as a data flow that may be shaped.
2. For each of the identified data flows, calculate the amount of resources for each flow that is needed for transmission as if the flow is shaped to a given bit rate.
   If the amount of resources freed by a possible shaping of a flow is larger than a threshold the flow may be shaped.
3. From the second step above, an amount of freed resources per cell is made available other flows (not to be shaped). Freed resources per cell when used herein means resources, such as radio resources like physical radio blocks that is not used by the shaped data flow due to the less flow bit rate provided to the RAN for this flow.
4. In this step a function is used for calculation of the potential benefits for the other flows of the other UEs 121, 122, 123, 124 based on the freed resource from step 3. This function decides which flows to finally shape and may be referred to as deciding in Action 503 above, how to shape the specific data flow, based on the second information.

Embodiments Wherein the RAN Node 110 Performs the Second Function

In these embodiments, the core network node 130 shapes the final flows to some given bitrates based on the second information which is based on the first information received from the RAN node 110. The RAN node 110 conveys, such as sends, which flows that can/will benefit other flows if shaped, i.e. the second information. See action above.

The second function is thus located in the RAN node 110, while the data flow shaper is the core network such as the core network node 130.

The GTP-U protocol or other protocol messages may be carriers of the information between the RAN such as the RAN node 110 and the core network such as the core network node 130. See FIG. 7 and FIG. 8.

When the RAN node 110 conveys, such as sends, which flows that can/will benefit other flows if shaped and the core network node 130 combines this information e.g. with the type of service and the QoS requirement for that service the core network node 130 may decide to shape that flow to lower bitrates, for example shape ABR videos. The RAN resources that gets available will in this way may be used by other flows in that cell.

The RAN node 110 obtains, e.g. by identifying data flows with, good, such as radio conditions above a given threshold or expressed as having possibility to transfer a given number of bits per resource. The identified flows are conveyed, such as sent, to the core network such as the core network node 130.

How Information May be Carried Between RAN and CN

FIG. 7 is a general figure showing a message exchange via e.g. the GTP-U or an IP-message, while FIG. 8 is a more concrete example of the GTP-U.

The information such as RAN core information e.g. comprising possible shaping flow, from the RAN such as the RAN node 110, referred to as eNodeB 110 in the FIGS. and 8, to the core network such as the core network node 130 referred to as UPS 130 in the FIGS. 7 and 8, may be conveyed using GTP-U extension headers. See FIG. 7 depicting RAN information sent from the RAN node 110 to the core network node 130 using GTP-U extensions. The first and or second information is comprised in a message such as added in GTP-U extension headers in eNodeB such as the RAN node 110 or UPF.

The first and or second information e.g. RAN core information e.g. comprising possible shaping flow, may as another alternative be comprised in a message such as added in a special user IP message sent to the core network node 130, see FIG. 8. FIG. 8 depicts RAN information such as any of the first and second information, sent from the RAN node 110 using the GTP-U with an extension destined to the core network node 130.

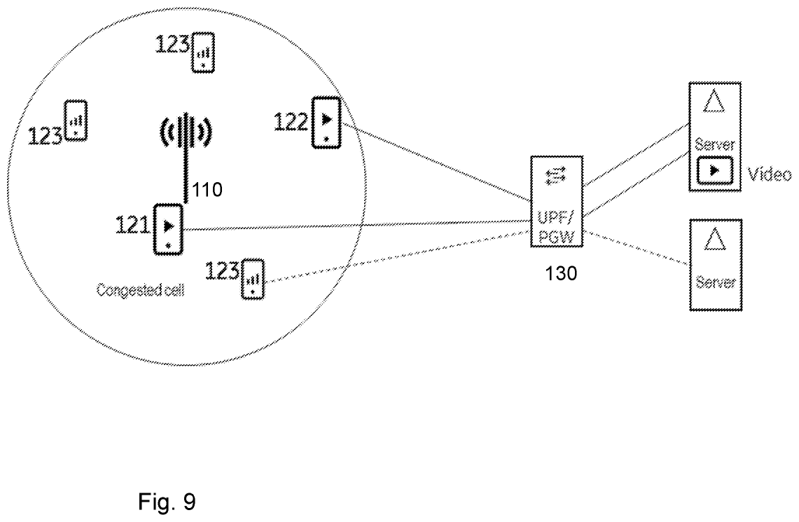

FIG. 9 depicts Core such as the core network node 130 shaping selected flows. The core network node 130 referred to as UPS/PGW 130 in the FIG. 9.

The UEs 121 and 122 are video users also referred to as elephant users, the other three UEs 123 are normal web users. An elephant flow is an extremely large, in total bytes, continuous flow.

The RAN node 110 conveys, such as sends, which data flows that may such as e.g. can and/or will benefit other data flows if shaped. That is the specific data flow.

The indication may be sent to UPF/PGW/TDF, using GTP-U extension headers see FIG. 8 or special user IP message se FIG. 7.

The core network node 130 sees that the UE 121 would benefit other flows if shaped.

Since the UE 121, in this example, is video and the core network node 130 knows which QoS requirement that this service may use, the conclusion is that the UE 121 flow will be shaped. Available RAN resources will be used by UE 122 as well as the other UEs in that cell.

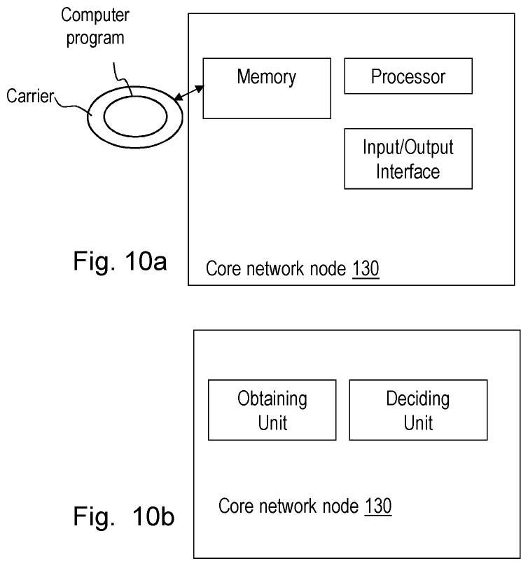

To perform the method actions above, the core network node 130 is configured to decide how to shape a specific data flow out of a number of data flows between the RAN, node 110 and the multiple UEs 121, 122, 123, 124 in the wireless communications network 100. The core network node 130 may comprise an arrangement depicted in FIGS. 10a and 10b. The core network node 130 may comprise an obtaining unit and a deciding unit.

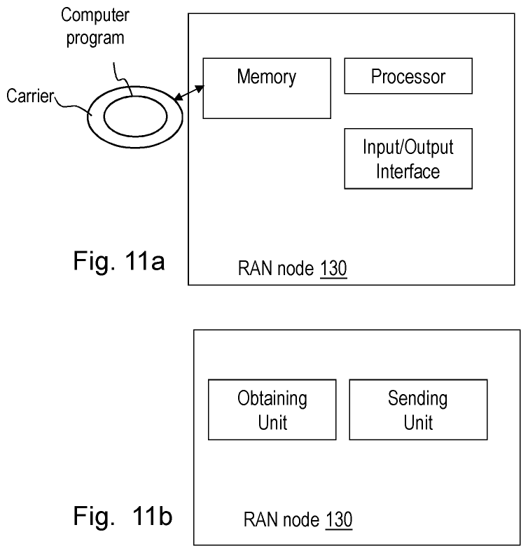

To perform the method actions above, the RAN node 110 is configured to assist the core network node 130 in deciding how to shape a specific data flow out of a number of data flows between the RAN, node 110 and the multiple UEs 121, 122, 123, 124 in the wireless communications network 100. The RAN node 110 may comprise an arrangement depicted in FIGS. 11a and 11b. The RAN node 110 may comprise an obtaining unit and a sending unit.

The core network node 130 and the RAN node 110 may comprise a respective input and output interface configured to communicate with network nodes such as the RAN node 110. The respective input and output interface may comprise a receiver (not shown) and a transmitter (not shown).

Those skilled in the art will appreciate that the units in the respective core network node 130 and the RAN node 110 described above may refer to a combination of analog and digital circuits, and/or one or more processors configured with software and/or firmware, e.g. stored in the respective core network node 130 and RAN node 110, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

The embodiments herein may be implemented through a respective processor or one or more processors, such as the processor of a processing circuitry in the core network node 130 depicted in FIG. 10a and the the RAN node 110 depicted in FIG. 11a, together with respective computer program code for performing the functions and actions of the embodiments herein. The program code mentioned above may also be provided as a computer program product, for instance in the form of a data carrier carrying computer program code for performing the embodiments herein when being loaded into the respective core network node 130 and RAN node 110. One such carrier may be in the form of a CD ROM disc. It is however feasible with other data carriers such as a memory stick. The computer program code may furthermore be provided as pure program code on a server and downloaded to the respective core network node 130 and RAN node 110.

The core network node 130 and RAN node 110 may further comprise a respective memory comprising one or more memory units. The respective memory comprises instructions executable by the processor in the respective core network node 130 and RAN node 110. The respective memory is arranged to be used to store e.g. information, indications, data, configurations, and applications to perform the methods herein when being executed in the respective core network node 130 and RAN node 110.

In some embodiments, a respective computer program comprises instructions, which when executed by the respective at least one processor, cause the at least one processor of the core network node 130 and RAN node 110 to perform the actions above.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium.

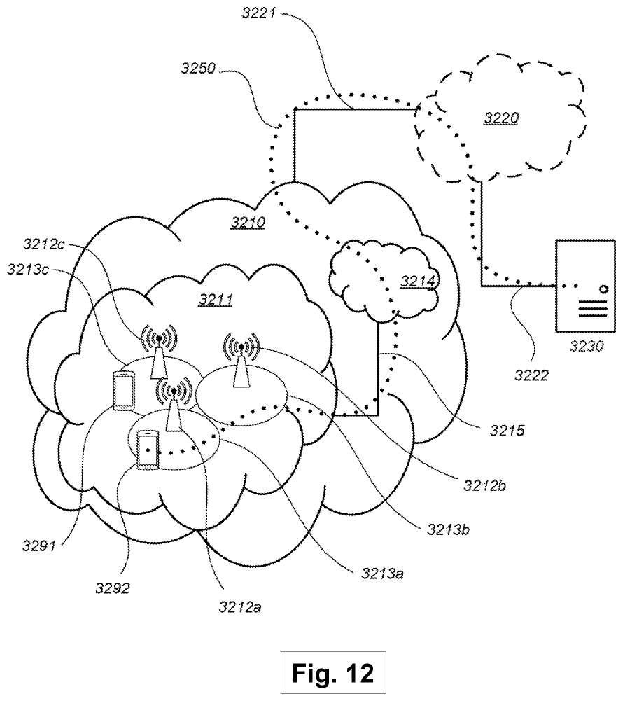

With reference to FIG. 12, in accordance with an embodiment, a communication system includes a telecommunication network 3210, such as a 3GPP-type cellular network e.g. the wireless communications network 100, which comprises an access network 3211, such as a radio access network, and a core network 3214 e.g. comprising the core network node 130. The access network 3211 comprises a plurality of base stations 3212a, 3212b, 3212c, e.g. the RAN node 110, such as AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 12 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE towards the host computer 3230.

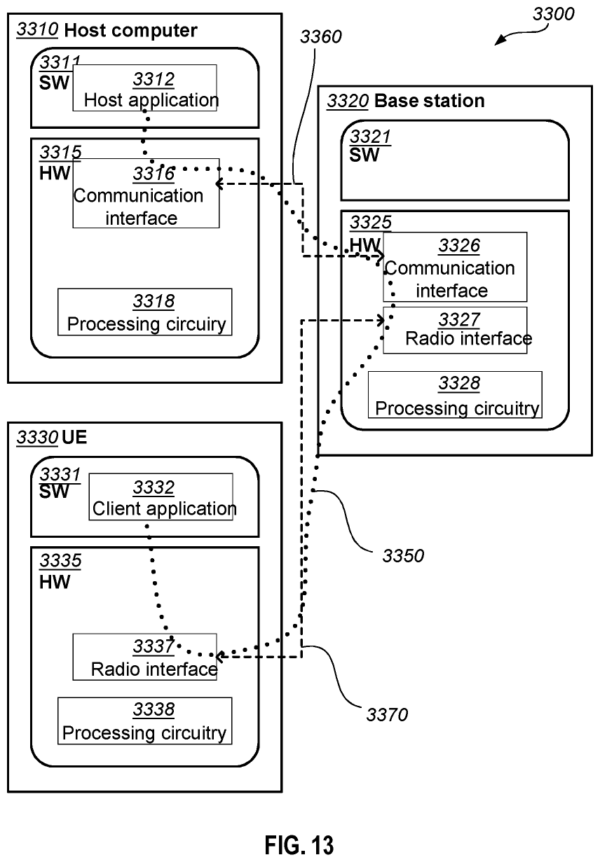

Example implementations, in accordance with an embodiment, of the UE, base station and host computer discussed in the preceding paragraphs will now be described with reference to FIG. 13. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 13) served by the base station 3320. The communication interface 3326 may be configured to facilitate a connection 3360 to the host computer 3310. The connection may be direct or it may pass through a core network (not shown in FIG. 13) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 13 may be identical to the host computer 3230, one of the base stations 3212a, 3212b, 3212c and one of the UEs 3291, 3292 of FIG. 12, respectively. This is to say, the inner workings of these entities may be as shown in FIG. 13 and independently, the surrounding network topology may be that of FIG. 12.

In FIG. 13, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection forms the last segment. More precisely, the teachings of these embodiments may improve the [select the applicable RAN effect: data rate, latency, power consumption] and thereby provide benefits such as [select the applicable corresponding effect on the OTT service: reduced user waiting time, relaxed restriction on file size, better responsiveness, extended battery lifetime].

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

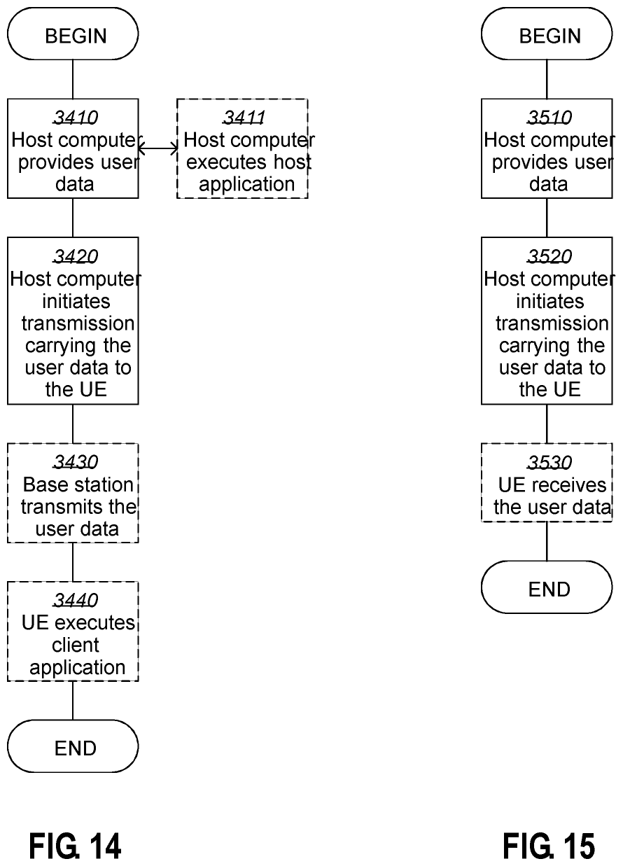

FIG. 14 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 14 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 15 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 15 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

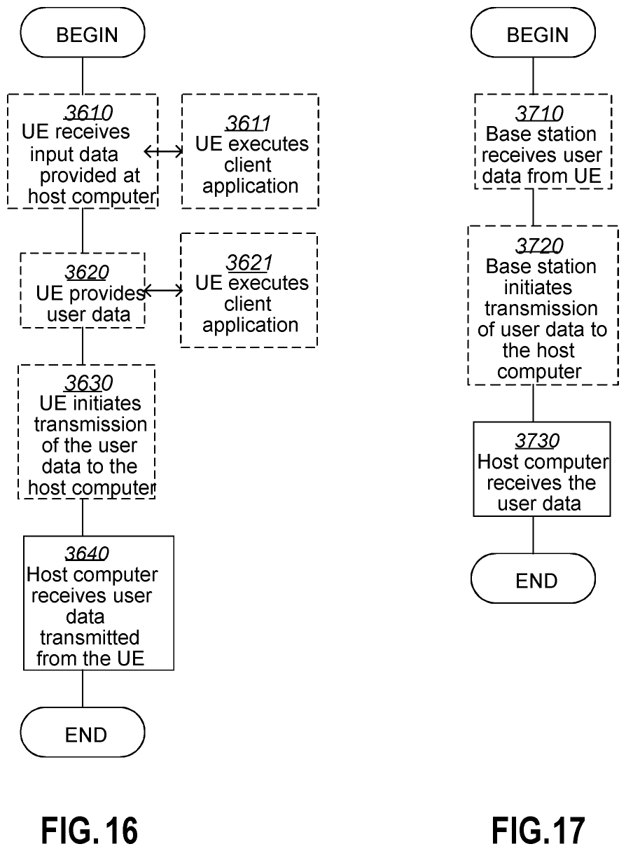

FIG. 16 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 16 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 17 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

Some example Embodiments numbered 1-32 are described below. These embodiments refer in particular to FIG. 3, 5, 6 and FIGS. 10a, b and 11a, b.

Embodiment 1. A method performed by a core network node 130 for deciding how to shape a specific data flow out of a number of data flows between a Radio Access Network, RAN, node 110 and multiple User Equipments, UEs, 121, 122, 123, 124 in a wireless communications network 100, the method comprising:

e.g. second function RAN and core, obtaining 502 a second information about which specific data flow out of the number of data flows, that will benefit other data flows out of the number of data flows, when shaping the specific data flow such that the bit rate of the specific data flow exceeds a threshold,

which second information is based on a first information comprising e.g. first function RAN for each data flow out of the number of data flows, information about the number of bits per radio resource of the data flow based on radio conditions of the UE 121, 122, 123, 124 involved in the data flow, and

deciding 503 how to shape the specific data flow, based on the second information.

Embodiment 2. The method according to embodiment 1, further comprising:

for each data flow out of the number of data flows, obtaining 501 the first information about the number of bits per radio resource of the data flow based on radio conditions of the UE 121, 122, 123, 124 involved in the data flow.

Embodiment 3. The method according to any of the embodiments 1-2, wherein shaping the specific data flow comprises any one or more out of: lowering bit rate of the specific data flow, lowering the burst rate of the specific data flow, changing the size of bursts in the specific data flow.

Embodiment 4. The method according to any of the embodiments 1-3, wherein:

the deciding 503 of how to shape the specific data flow, based on the second information is further based on any one or more out of: the type of data flow of the specific data flow and the QoS of the type of data flow of the specific data flow.

Embodiment 5. The method according to any of the embodiments 1-4, wherein:

the second information is obtained 502 by being calculated in the core network node 130.

Embodiment 6. The method according to any of the embodiments 1-5, wherein:

the second information is obtained 502 by being calculated based on any one or more out of:

the amount of data related to each UE out of the multiple UEs 121, 122, 123, 124 for its one or more data flows out of the number of data flows,

the service type of the respective data flow out of the number of data flows, and

the QoS requirement of the respective data flow out of the number of data flows.

Embodiment 7. The method according to any of the embodiments 1-4, wherein:

the second information is obtained 502 by being received in a message from the RAN node 110.

Embodiment 8. The method according to any of the embodiments 1-7, wherein:

the first information is obtained 501 by being received in a message from the RAN node 110.

Embodiment 9. The method according to any of the embodiments 7-8, wherein any one or more out of the first information and the second information is received in any one out of:

a General packet radio service Tunneling Protocol-User plane, GTP-U, extension header of a message, or

a user plane Internet Protocol, IP, message.

Embodiment 10. A computer program comprising instructions, which when executed by a processor, causes the processor to perform actions according to any of the embodiments 1-9.

Embodiment 11. A carrier comprising the computer program of embodiment 10, wherein the carrier is one of an electronic signal, an optical signal, an electromagnetic signal, a magnetic signal, an electric signal, a radio signal, a microwave signal, or a computer-readable storage medium.

Embodiment 12. A method performed by a Radio Access Network, RAN, 110 for assisting a core network node 130 in deciding how to shape a specific data flow out of a number of data flows between the RAN node 110 and multiple User Equipments, UEs, 121, 122, 123, 124 in a wireless communications network 100, the method comprising any one out of:

e.g. first function RAN, for each data flow out of the number of data flows, obtaining a first information about the number of bits per radio resource of the data flow based on a measured radio conditions of the UE 121, 122, 123, 124 involved in the data flow,

e.g. second function RAN and core based on the obtained first information about the number of bits per resource of the respective data flow, obtaining 603 a second information about which specific data flow out of the number of data flows, that will benefit other data flows out of the number of data flows, when shaping the specific data flow such that the bit rate of the specific data flow exceeds a threshold, and

sending 604 information in a message to the core network node 130, which information comprises any one out of: the first information or the first information and the second information, which information enables the core network node 130 to decide how to shape the specific data flow.

Embodiment 13. The method according to embodiment 12, further comprising:

sending 602 a message to the core network node 130, which message comprises the first information.

Embodiment 14. The method according to any of the embodiments 12-13, wherein shaping the specific data flow comprises any one or more out of: lowering bit rate of the specific data flow, lowering the burst rate of the specific data flow, changing the size of bursts in the specific data flow.

Embodiment 15. The method according to any of the embodiments 12-14, wherein:

the second information is obtained 603 by being calculated based on any one or more out of:

the amount of data related to each UE out of the multiple UEs 121, 122, 123, 124 for its one or more data flows out of the number of data flows,

the service type of the respective data flow out of the number of data flows, and

the QoS requirement of the respective data flow out of the number of data flows.

Embodiment 16. The method according to any of the embodiments 12-15, wherein any one or more out of the first information and the second information is sent to the core network node 130 in any one out of:

a General packet radio service Tunneling Protocol-User plane, GTP-U, extension header of a message, or

a user plane Internet Protocol, IP, message.

Embodiment 17. A computer program comprising instructions, which when executed by a processor, causes the processor to perform actions according to any of the embodiments 12-16.

Embodiment 18. A carrier comprising the computer program of embodiment 17, wherein the carrier is one of an electronic signal, an optical signal, an electromagnetic signal, a magnetic signal, an electric signal, a radio signal, a microwave signal, or a computer-readable storage medium.

Embodiment 19. A core network node 130 configured to decide how to shape a specific data flow out of a number of data flows between a Radio Access Network, RAN, node 110 and multiple User Equipments, UEs, 121, 122, 123, 124 in a wireless communications network 100, the core network node 130 further being configured to:

obtain a second information about which specific data flow out of the number of data flows, that will benefit other data flows out of the number of data flows, when shaping the specific data flow such that the bit rate of the specific data flow exceeds a threshold, e.g. by means of an obtaining unit in the core network node 130,

which second information is based on a first information comprising for each data flow out of the number of data flows, information about the number of bits per radio resource of the data flow based on radio conditions of the UE 121, 122, 123, 124 involved in the data flow, and

decide how to shape the specific data flow, based on the second information, e.g. by means of a deciding unit in the core network node 130.

Embodiment 20. The core network node 130 according to embodiment 19, further being configured to:

for each data flow out of the number of data flows, obtain the first information about the number of bits per radio resource of the data flow based on radio conditions of the UE 121, 122, 123, 124 involved in the data flow, e.g. by means of the obtaining unit in the core network node 130.

Embodiment 21. The core network node 130 according to any of the embodiments 19-20, wherein shaping the specific data flow is adapted to comprise any one or more out of: lowering the bit rate of the specific data flow, lowering the burst rate of the specific data flow, changing the size of bursts in the specific data flow.

Embodiment 22. The core network node 130 according to any of the embodiments 19-21, further being configured to:

decide how to shape the specific data flow based on the second information further based on any one or more out of: the type of data flow of the specific data flow and the QoS of the type of data flow of the specific data flow e.g. by means of a deciding unit in the core network node 130.

Embodiment 23. The core network node 130 according to any of the embodiments 19-22, wherein:

the second information is adapted to be obtained by being received in a message from the RAN node 110.

Embodiment 24. The core network node 130 according to any of the embodiments 19-24, wherein:

the second information is adapted to be obtained by being calculated based on any one or more out of:

the amount of data related to each UE out of the multiple UEs 121, 122, 123, 124 for its one or more data flows out of the number of data flows,

the service type of the respective data flow out of the number of data flows, and

the QoS requirement of the respective data flow out of the number of data flows.

Embodiment 25. The core network node 130 according to any of the embodiments 19-22, wherein:

the second information is adapted to be obtained by being calculated in the core network node 130.

Embodiment 26. The core network node 130 according to any of the embodiments 19-25, wherein:

the first information is adapted to obtained by being received in a message from the RAN node 110.

Embodiment 27. The core network node 130 according to any of the embodiments 25-26, wherein any one or more out of the first information and second information is received in any one out of:

a General packet radio service Tunneling Protocol-User plane, GTP-U, extension header of a message, or

a user plane Internet Protocol, IP, message.

Embodiment 28. A Radio Access Network, RAN, node 110 configured to assist a core network node 130 in deciding how to shape a specific data flow out of a number of data flows between the RAN node 110 and multiple User Equipments, UEs, 121, 122, 123, 124 in a wireless communications network 100, the RAN 110 node further being configured to any one out of:

for each data flow out of the number of data flows, obtain a first information about the number of bits per radio resource of the data flow based on a measured radio conditions of the UE 121, 122, 123, 124 involved in the data flow, e.g. by means of an obtaining unit in the RAN node 110,

based on the obtained first information about the number of bits per resource of the respective data flow, obtain a second information about which specific data flow out of the number of data flows, that will benefit other data flows out of the number of data flows, when shaping the specific data flow such that the bit rate of the specific data flow exceeds a threshold, e.g. by means of the obtaining unit in the RAN node 110, and

send information in a message to the core network node 130, which information is adapted to comprise any one out of: the first information or the first information and the second information, which information enables the core network node 130 to decide how to shape the specific data flow, e.g. by means of an sending unit in the RAN node 110.

Embodiment 29. The RAN 110 node according to embodiment 28, further being configured to:

send a message to the core network node 130, which message comprises the first information, e.g. by means of the sending unit in the RAN node 110.

Embodiment 30. The RAN 110 node according to any of the embodiments 28-29, wherein shaping the specific data flow is adapted to comprise any one or more out of: lowering bit rate of the specific data flow, lowering the burst rate of the specific data flow, changing the size of bursts in the specific data flow.

Embodiment 31. The RAN 110 node according to any of the embodiments 28-30, wherein:

the second information is adapted to be obtained by being calculated based on any one or more out of:

the amount of data related to each UE out of the multiple UEs 121, 122, 123, 124 for its one or more data flows out of the number of data flows,

the service type of the respective data flow out of the number of data flows, and

the QoS requirement of the respective data flow out of the number of data flows.

Embodiment 32. The RAN 110 node according to any of the embodiments 28-31, wherein any one or more out of the first information and second information is adapter to be sent to the core network node 130 in any one out of:

a General packet radio service Tunneling Protocol-User plane, GTP-U, extension header of a message, or

a user plane Internet Protocol, IP, message.

1-32. (canceled)

33. A method performed by a core network node for deciding how to shape a specific data flow out of a number of data flows between a Radio Access Network (RAN) node and multiple User Equipments (UEs) in a wireless communications network, the method comprising:
obtaining a second information about which specific data flow out of the number of data flows, that will benefit other data flows out of the number of data flows, when shaping the specific data flow such that the bit rate of the specific data flow exceeds a threshold;
which second information is based on a first information comprising for each data flow out of the number of data flows, information about the number of bits per radio resource of the data flow based on radio conditions of the UE involved in the data flow; and
deciding how to shape the specific data flow, based on the second information.

34. The method according to claim 33, further comprising, for each data flow out of the number of data flows, obtaining the first information about the number of bits per radio resource of the data flow based on radio conditions of the UE involved in the data flow.

35. The method according to claim 33, wherein shaping the specific data flow comprises any one or more out of: lowering bit rate of the specific data flow, lowering the burst rate of the specific data flow, or changing the size of bursts in the specific data flow.

36. The method according to claim 33, further comprising deciding how to shape the specific data flow further based on any one or more out of: the type of data flow of the specific data flow, or the QoS of the type of data flow of the specific data flow.

37. The method according to claim 33, wherein the second information is obtained by being calculated based on any one or more out of: the amount of data related to each UE out of the multiple UEs for its one or more data flows out of the number of data flows; the service type of the respective data flow out of the number of data flows; or the QoS requirement of the respective data flow out of the number of data flows.

38. The method according to claim 33, wherein the first information is obtained by being received in a message from the RAN node.

39. The method according to claim 33, wherein the second information is obtained by being received in a message from the RAN node.

40. The method according to claim 33, wherein any one or more out of the first information and the second information is received in any one out of:
a General packet radio service Tunneling Protocol-User plane (GTP-U) extension header of a message, or
a user plane Internet Protocol (IP) message.

41. A method performed by a Radio Access Network (RAN) node for assisting a core network node in deciding how to shape a specific data flow out of a number of data flows between the RAN node and multiple User Equipments (UEs) in a wireless communications network, the method comprising:
for each data flow out of the number of data flows, obtaining a first information about the number of bits per radio resource of the data flow based on a measured radio conditions of the UE involved in the data flow,
based on the obtained first information about the number of bits per resource of the respective data flow, obtaining a second information about which specific data flow out of the number of data flows, that will benefit other data flows out of the number of data flows, when shaping the specific data flow such that the bit rate of the specific data flow exceeds a threshold, and
sending information in a message to the core network node, which information comprises any one out of: the first information or the first information and the second information, which information enables the core network node to decide how to shape the specific data flow.

42. The method according to claim 41, further comprising sending a message to the core network node, which message comprises the first information.

43. The method according to claim 41, wherein shaping the specific data flow comprises any one or more out of: lowering bit rate of the specific data flow, lowering the burst rate of the specific data flow, changing the size of bursts in the specific data flow.

44. The method according to claim 41, wherein the second information is obtained by being calculated based on any one or more out of: the amount of data related to each UE out of the multiple UEs for its one or more data flows out of the number of data flows, the service type of the respective data flow out of the number of data flows, or the QoS requirement of the respective data flow out of the number of data flows.

45. A core network node operative to decide how to shape a specific data flow out of a number of data flows between a Radio Access Network (RAN) node and multiple User Equipments (UEs) in a wireless communications network, the core network node being configured to:
obtain a second information about which specific data flow out of the number of data flows, that will benefit other data flows out of the number of data flows, when shaping the specific data flow such that the bit rate of the specific data flow exceeds a threshold, which second information is based on a first information comprising for each data flow out of the number of data flows, information about the number of bits per radio resource of the data flow based on radio conditions of the UE involved in the data flow; and
decide how to shape the specific data flow, based on the second information.

46. The core network node according to claim 45, further being configured to, for each data flow out of the number of data flows, obtain the first information about the number of bits per radio resource of the data flow based on radio conditions of the UE involved in the data flow.

47. The core network node according to claim 45, wherein shaping the specific data flow comprises any one or more out of: lowering the bit rate of the specific data flow, lowering the burst rate of the specific data flow, or changing the size of bursts in the specific data flow.

48. The core network node according to claim 45, being configured to decide how to shape the specific data flow further based on any one or more out of: the type of data flow of the specific data flow, or the QoS of the type of data flow of the specific data flow.

49. The core network node according to claim 45, wherein the second information is obtained by being calculated based on any one or more out of:
the amount of data related to each UE out of the multiple UEs for its one or more data flows out of the number of data flows;
the service type of the respective data flow out of the number of data flows; or
the QoS requirement of the respective data flow out of the number of data flows.

50. The core network node according to claim 45, wherein the second information is obtained by being calculated in the core network node.

51. The core network node according to claim 45, wherein the first information is obtained by being received in a message from the RAN node.

52. A Radio Access Network (RAN) node operative to assist a core network node in deciding how to shape a specific data flow out of a number of data flows between the RAN node and multiple User Equipments (UEs) in a wireless communications network, the RAN node being configured to:
for each data flow out of the number of data flows, obtain a first information about the number of bits per radio resource of the data flow based on a measured radio conditions of the UE involved in the data flow;
based on the obtained first information about the number of bits per resource of the respective data flow, obtain a second information about which specific data flow out of the number of data flows, that will benefit other data flows out of the number of data flows, when shaping the specific data flow such that the bit rate of the specific data flow exceeds a threshold; and
send information in a message to the core network node, which information is adapted to comprise any one out of: the first information or the first information and the second information, which information enables the core network node to decide how to shape the specific data flow.
